(19) United States
(12) Patent Application Publication
(10) Pub. No.: US 2008/0047631 A1
(43) Pub. Date: Feb. 28, 2008

(54) Funnel in combination with a commercial appliance

(76) Inventor: Scott Baker, Irving, TX (US)

Correspondence Address: JACKSON WALKER LLP, 901 MAIN STREET, SUITE 6000, DALLAS, TX, 75202-3797, US

(21) Appl. No.: 11/825,939

(22) Filed: Jul. 10, 2007

Related U.S. Application Data
(60) Provisional application No. 60/830,244, filed on Jul. 12, 2006.

(51) Int. Cl. B65B 39/00; B65B 39/02; B67C 11/00

(52) U.S. Cl. 141/332; 141/337; 222/460

(57) ABSTRACT

A funnel in combination with a commercial appliance, such as a refrigerator or icemaker, that will allow a product, such as water or ice, to be redirected and dispensed into a container that would otherwise be too large to fit into a recessed dispensing cavity typically allotted for smaller containers. To accomplish this, a sleeve member is operably coupled to the appliance in either a friction-fit arrangement or a mounting arrangement at or around an optimal deflection angle of 30°, thus allowing the water or ice to overcome a lip on the dispensing cavity and be redirected into a larger container.

### CLAIM OF PRIORITY

This application claims priority of U.S. Provisional Application Ser. No. 60/830,244, filed Jul. 12, 2006 entitled “FUNNEL” the entire teachings of which are incorporated herein by this reference.

### TECHNICAL FIELD

The present invention generally relates to the field of funnels, and more particularly to a funnel used in combination with a commercial appliance, such as a refrigerator or icemaker, to redirect a product, such as water or ice into a container typically too large to fit into a recessed dispensing cavity on a refrigerator door.

### BACKGROUND OF THE INVENTION

With the increase of built-in combination water and ice dispensers included in refrigerators today, the demand for a way to fill containers larger than what can typically fit in the dispensing cavity also increases.

The majority of today's refrigerators typically include combination water and ice dispensers on the front of the refrigerator, as well as a dispensing cavity that is recessed into the front of one of the refrigerator doors. This recessed dispensing cavity allows a user to insert a small container, such as a standard-sized drinking glass, and easily dispense water or ice from the dispensers housed above the dispensing cavity in the refrigerator door into the container. The majority of these refrigerators also include a purification system for the water used for both dispensing water and also making and dispensing ice. Today's health conscious culture has caused many users to want to use the purified water and ice from the refrigerator for more than just drinking; users now want to use the cheap, purified water from the refrigerator for coffee, cooking, ironing, and watering household plants, among other uses.

Although the dispensing cavity easily holds containers smaller than the dimensions of the cavity, user often find themselves wanting to fill larger containers, such as large water bottles, ice buckets, and the like, or awkwardly shaped containers and appliances such as coffee pots, watering pails, irons, and the like with purified water and ice from the refrigerator. Typically, the dimensions of the dispensing cavity in the refrigerator door prohibit containers larger than those dimensions in either height or width from easily being used with the water or ice dispensers. While users can sometimes use larger containers by holding them at an angle to the refrigerator door, thus overcoming the limitations imposed by the size of the dispensing cavity, this only works for containers that are narrow enough at the container input to be inserted into the dispensing cavity. The angle of the container prohibits the container from being fully filled without spilling water or ice onto the floor. Also, the opaque nature of many containers prohibit users from being able to see when the dispensed water or ice is approaching the top of the container when it is in the dispensing cavity, often resulting in water or ice overflowing the brim of the container.

### SUMMARY OF THE INVENTION

Accordingly, there exists a need for a funnel in combination with a refrigerator to redirect dispensed water and ice into large or awkwardly shaped containers in order to overcome the size limitations imposed by the dispensing cavity. Moreover, such a funnel would advantageously allow the user to fill opaque containers with water or ice without over-filling the container by moving the mouth of the container from inside the dispensing cavity to outside the refrigerator, allowing the user to easily see when the water or ice is approaching the top of the container.

A solution to this challenge is to create a funnel in combination with a commercial appliance, such as a refrigerator or icemaker, that will allow a product, such as water or ice, to be redirected and dispensed into a container that would otherwise be too large to fit into a recessed dispensing cavity typically allotted for smaller containers. To accomplish this, a sleeve member is operably coupled to the appliance in either a friction-fit arrangement or a mounting arrangement at or around an optimal deflection angle of 30°, thus allowing the water or ice to overcome a lip on the dispensing cavity and be redirected into a larger container.

### BRIEF DESCRIPTION OF THE DRAWINGS

Advantages of the invention and the specific embodiments will be understood by those of ordinary skill in the art by reference to the following detailed description of exemplary embodiments taken in conjunction with the drawings, in which:

FIG. 1 shows a front view of a rigid funnel sleeve member;

FIG. 2 shows a side view of a rigid funnel sleeve member;

FIG. 3 shows in profile a rigid funnel sleeve member in combination with a commercial appliance;

FIG. 4 shows an accordion funnel sleeve member in an extended position;

FIG. 5 shows an accordion funnel sleeve member in a retracted position;

FIG. 6 shows in profile an accordion funnel sleeve member in combination with a commercial appliance coupled to a dispenser in a friction fit arrangement;

FIG. 7 shows a front view of a L-shaped funnel sleeve member;

FIG. 8 shows a side view of a L-shaped funnel sleeve member;

FIG. 9 shows a side view of a mounting bracket;

FIG. 10 shows a rear view of a mounting bracket;

FIG. 11 shows a front view of a mounting bracket;

FIG. 12 shows a top view of a mounting bracket;

FIG. 13 shows in profile a L-shaped funnel sleeve member in combination with a commercial appliance coupled to a dispenser with a mounting bracket.

### DETAILED DESCRIPTION OF THE PREFERRED EMBODIMENT

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others.

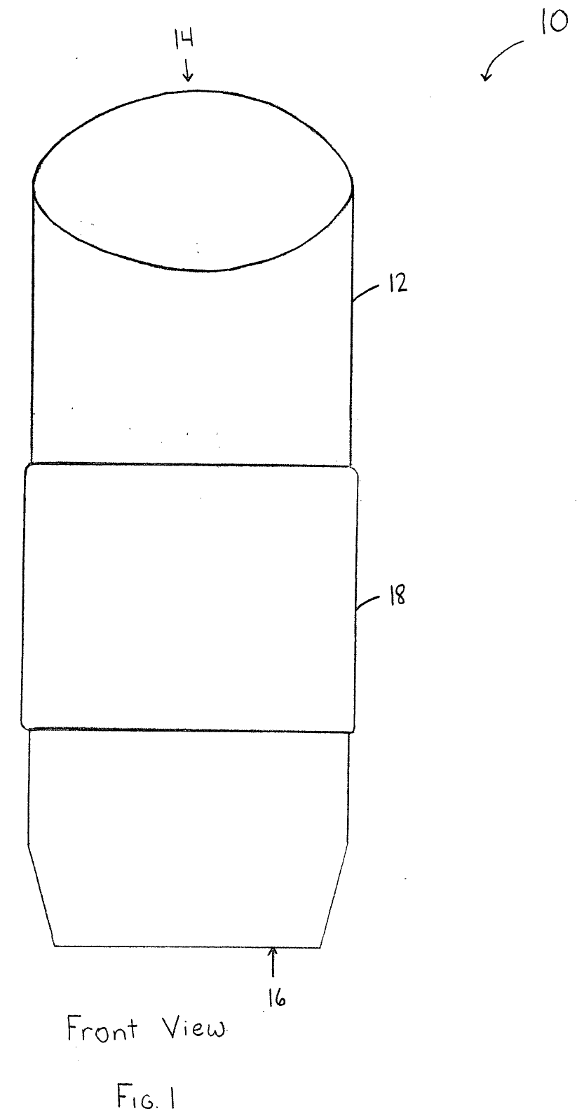

There is shown in FIG. 1 a front view of a rigid funnel sleeve member 10 having a cylindrical body 12, a member input 14, a member output 16, and a non-slip grip 18. In an exemplary embodiment, the cylindrical body 12 is made from a hard plastic, although it can also be made from a metal or any other suitable material. The cylindrical body 12, in an exemplary embodiment, is continuous from member input 14 to member output 16, with the diameter of member input 14 in the horizontal plane larger than member output 16 in the horizontal plane in order to redirect a product such as water or ice, although it can also be any other suitable product, while the member input 14 is large enough to not clog with ice. The non-slip grip 18, in an exemplary embodiment, slides over the cylindrical body 12 and is used as an over grip when holding the rigid funnel sleeve member 10 to a refrigerator dispenser. In a second exemplary embodiment, the non-slip grip 18 is structurally part of the rigid funnel sleeve member 10 and bisects the upper metal cylindrical body 12 and the lower cylindrical body 12.

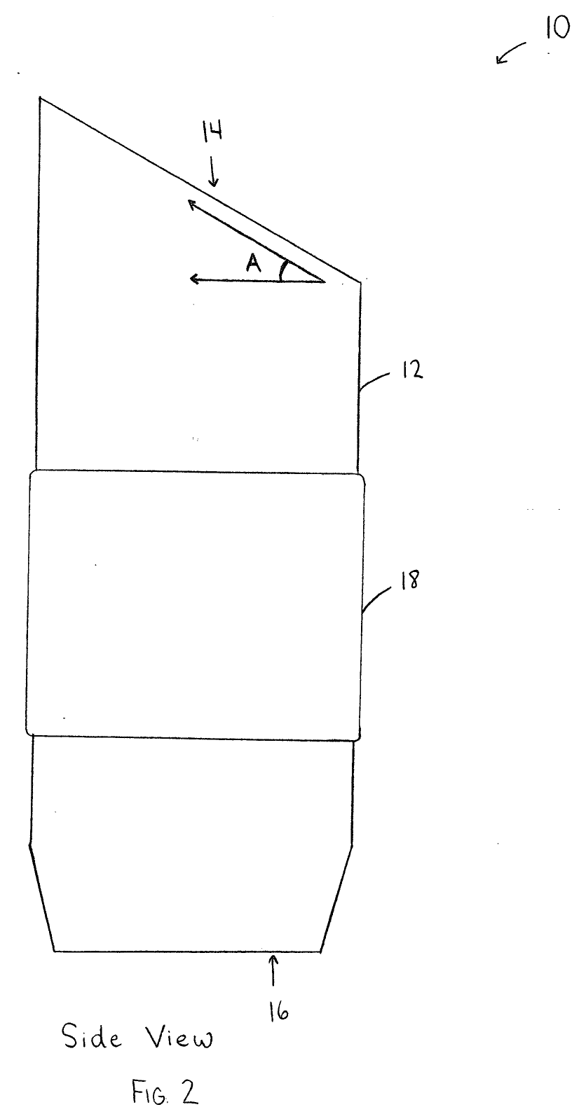

Referring now to FIG. 2 there is shown a side view of the rigid funnel sleeve member 10 as depicted in FIG. 1 in accordance with an exemplary embodiment of the present invention. As discussed previously in FIG. 1 and herein in greater detail, the sleeve member 10, in an exemplary embodiment, comprises the cylindrical body 12, the member input 14, the member output 16, the non-slip grip 18, and a fixed deflection angle A with respect to the horizontal plane. The minimum deflection angle A, with respect to the horizontal, is 20°, although the optimal deflection angle is 30° in this exemplary embodiment.

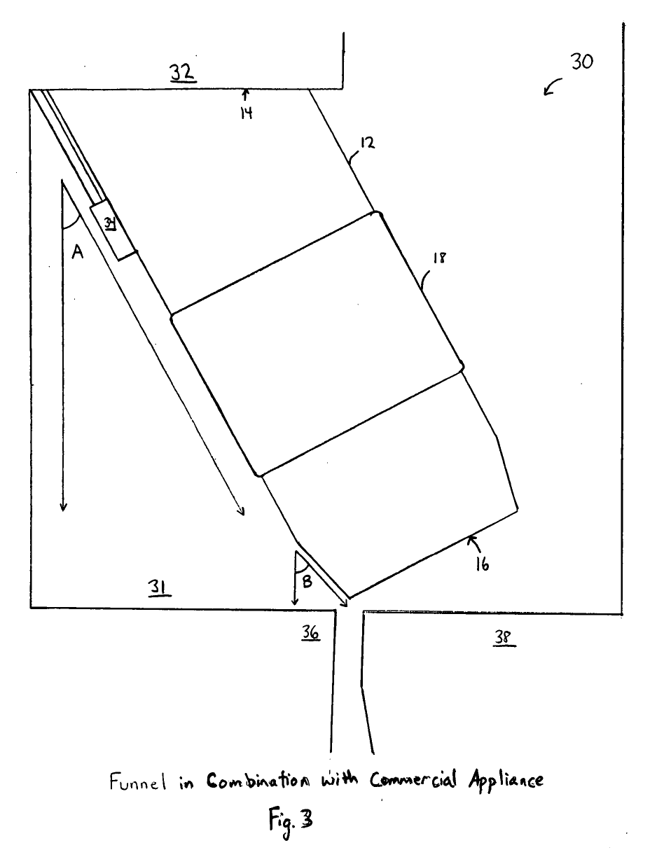

Referring now to FIG. 3 there is shown in profile a rigid funnel sleeve member in combination with a commercial appliance 30 in accordance with an exemplary embodiment of the present invention. As discussed previously in FIG. 1 and FIG. 2 and herein in greater detail, the rigid funnel sleeve member in combination with a commercial appliance 30, in a preferred embodiment, comprises the cylindrical body 12, the sleeve member input 14, the sleeve member outlet 16, the non-slip grip 18, the deflection angle A, a recessed dispensing cavity 31, an appliance output dispensing area 32, a dispensing pedal 34, a dispensing cavity lip 36, a receiving container 38, and a redirected angle B with respect to the vertical plane.

When used in combination, the rigid funnel sleeve member, in an exemplary embodiment, is operably coupled to the water and ice dispenser area 32 at sleeve member input 14 by hand and held around non-slip grip 18 at deflection angle A. The cylindrical body 12 is held against dispensing pedal 34, which can be either dispensing pedal located along the posterior surface of the cylindrical body 12 inside recessed dispensing cavity 31 or a dispensing button located on the rearward wall of the dispensing cavity 31. When the dispensing pedal 34 is depressed by the posterior surface of the cylindrical body 12, product from the appliance output dispensing area 32 is released through the sleeve member input 14, redirected at deflection angle A through the cylindrical body 12, and dispensed via the sleeve member output 16 into container 38. The redirected angle B is always at least as great as deflection angle A, and the deflection angle A allows the dispensed product to be redirected at redirected angle B in order to overcome the dispensing cavity lip 36. This allows container 38, which can be larger than the dimensions of recessed dispensing cavity 31, to be filled while it is either being held by the user or on a stationary object.

In a second exemplary embodiment, the dispensing pedal 34 is a dispensing button located on the rearward wall of recessed dispensing cavity 31 out of reach of cylindrical body 12, thus requiring the container 38 to be placed on a stationary object so that the user can hold the non-slip grip 18 with one hand and depress the dispensing pedal 34 with the other hand while reaching around the cylindrical body 12 in order to dispense product into the container 38. In this embodiment, the horizontal diameter of the cylindrical body as shown in FIG. 1 can be smaller than the width of the recessed dispensing cavity on the anterior of the commercial appliance and small enough to allow ample space for the user to be able to reach around the posterior surface of the cylindrical body 12 in order to depress the dispensing pedal 34.

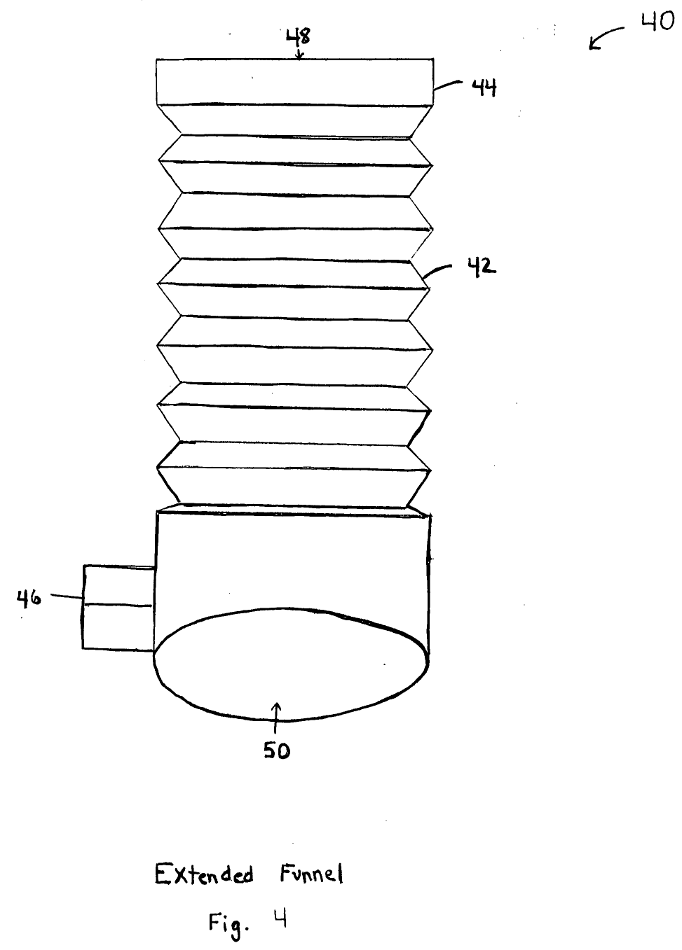

Referring now to FIG. 4 there is shown an accordion funnel sleeve member 40 in an extended position having an accordion-like body 42, a friction-fit collar 44, a grip lever 46, a member input 48, and a member output 50. In an exemplary embodiment, the accordion-like body 42 is made from a plastic, although it can also be made from a rubber, fabric, or any other suitable material. The accordion-like body 42, in an exemplary embodiment, is continuous from member input 48 to member output 50, with the diameter of member input 48 in the horizontal plane larger than member output 50 in the horizontal plane in order to redirect a product such as water or ice, although it can also be any other suitable product, while the member input 48 is large enough to not clog with ice. The friction-fit collar 44 allows the accordion funnel sleeve member 40 to be operably coupled to an appliance outlet to prevent the user from having to hold the sleeve member in the coupled position during operation. The grip lever 46 is held by the user and is used to pull the accordion-like body 42 from the retracted position to the extended position.

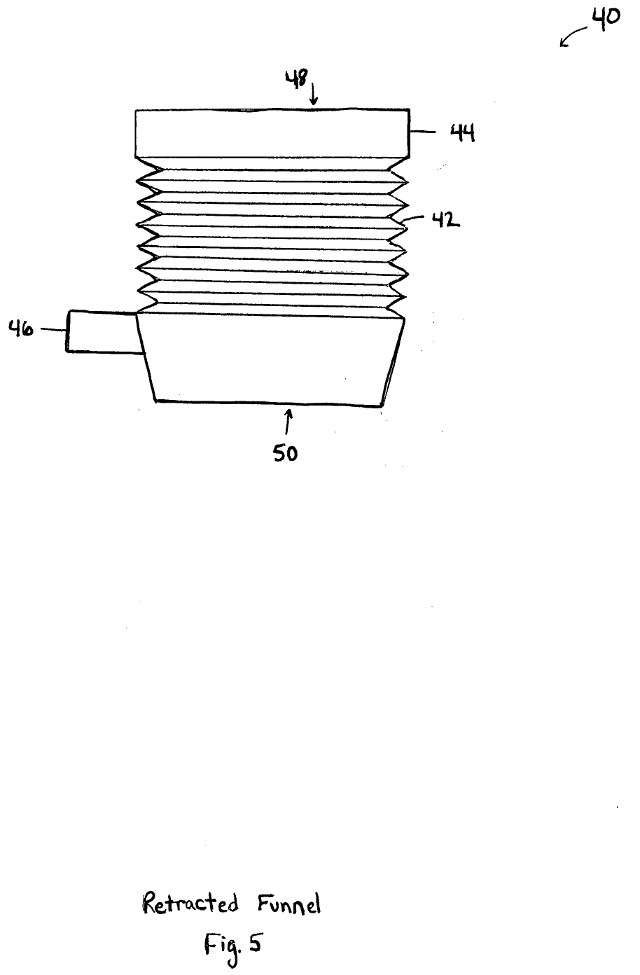

Referring now to FIG. 5 there is shown an accordion funnel sleeve member 40 in a retracted position having an accordion-like body 42, a friction-fit collar 44, a grip lever 46, a member input 48, and a member output 50.

Referring now to FIG. 6 there is shown in profile an accordion funnel sleeve member in combination with a commercial appliance 60 in accordance with an exemplary embodiment of the present invention. As discussed previously in FIG. 4 and FIG. 5 and herein in greater detail, the accordion funnel sleeve member in combination with a commercial appliance 60, in an exemplary embodiment, comprises the accordion-like body 42, the friction-fit collar 44, the grip lever 46, the member input 48, the member output 50, a recessed dispensing cavity 61, an appliance output dispensing area 62, a dispensing button 64, a dispensing cavity lip 66, a receiving container 68, a variable deflection angle A, and a redirected angle B with respect to the vertical plane.

When used in combination, the accordion funnel sleeve member, in an exemplary embodiment, is operably coupled to the water and ice dispenser area 62 at friction-fit collar 44 at variable deflection angle A. The grip lever 46 is held by the user and is used to pull the accordion-like body from the retracted position to the extended position. The accordion-like body 42 is rigid and rigid once in the extended position in this embodiment. When the user depresses dispensing button 64, which can be a dispensing button located on the rearward wall of the dispensing cavity 61 or a dispensing pedal situated along the posterior surface of the accordion-like body 42, with one hand, product from the appliance output dispensing area 62 is released through the friction-fit collar 44 and sleeve member input 48, redirected at deflection angle A through the accordion body 42, and dispensed via the sleeve member output 50 into container 68, which is held by the other hand. The redirected angle B is always at least as great as deflection angle A, and the deflection angle A allows the dispensed product to be redirected at redirected angle B in order to overcome the dispensing cavity lip 66. This allows container 68, which can be larger than the dimensions of recessed dispensing cavity 61, to be filled while it is placed on a stationary object.

In a second exemplary embodiment, the accordion-like body 42 remains flexible in the extended position and can be moved in any three dimensional direction in order to extend, retract, or bend the accordion-like body 42 to the correct dispensing position, thus requiring the container 68 to be placed on a stationary object so that the user can hold the grip lever 46 with one hand and depress the dispensing button 64 with the other hand while reaching around the accordion body 42 in order to dispense product into the container 68. In this embodiment, the horizontal diameter of the accordion body as shown in FIG. 4 can be smaller than the width of the recessed dispensing cavity 61 on the anterior of the commercial appliance and small enough to allow ample space for the user to be able to reach around the posterior surface of the accordion body 42 in order to depress the dispensing button 64 located directly behind the posterior surface of the accordion body 42.

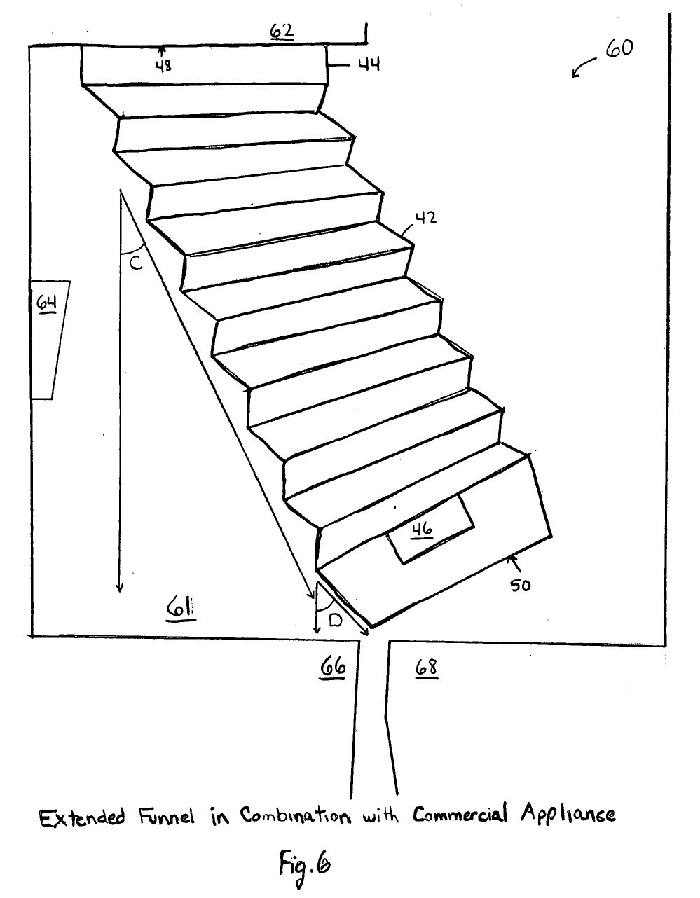

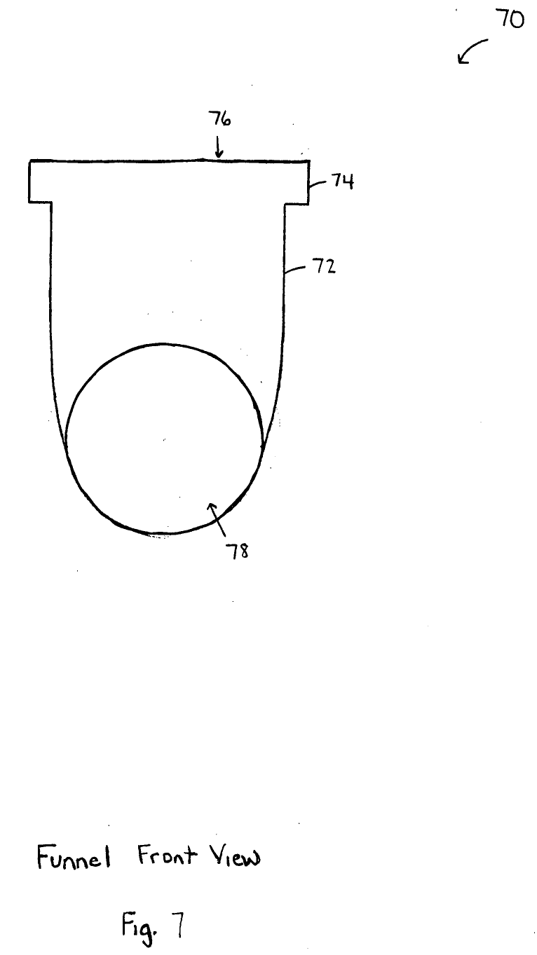

Referring now to FIG. 7 there is shown a front view of a L-shaped funnel sleeve member 70 having a L-shaped cylindrical body 72, a mounting bracket lip 74, a member input 76, and a member output 78. In an exemplary embodiment, the L-shaped body. 72 is made from a metal, although it can also be made from a plastic, rubber, or any other suitable material. The L-shaped body 72, in a preferred embodiment, is continuous from member input 76 to member output 78, with the diameter of member input 76 in the horizontal plane larger than member output 78 in the vertical plane in order to redirect a product such as water or ice, although it can also be any other suitable product, while the member input 76 is large enough to not clog with ice.

Referring now to FIG. 8 there is shown a side view of the L-shaped funnel sleeve member 10 as depicted in FIG. 7 in accordance with an exemplary embodiment of the present invention. As discussed previously in FIG. 7 and herein in greater detail, the L-shaped funnel sleeve member 70, in an exemplary embodiment, comprises the L-shaped body 72, the mounting bracket lip 74, the member input 76, and the member output 78.

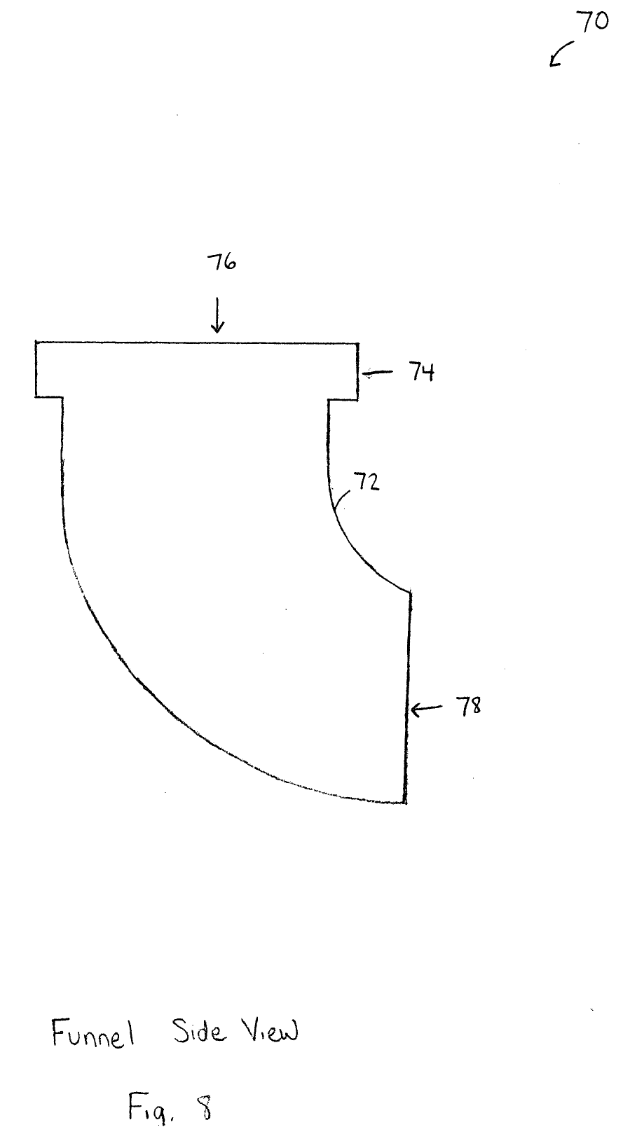

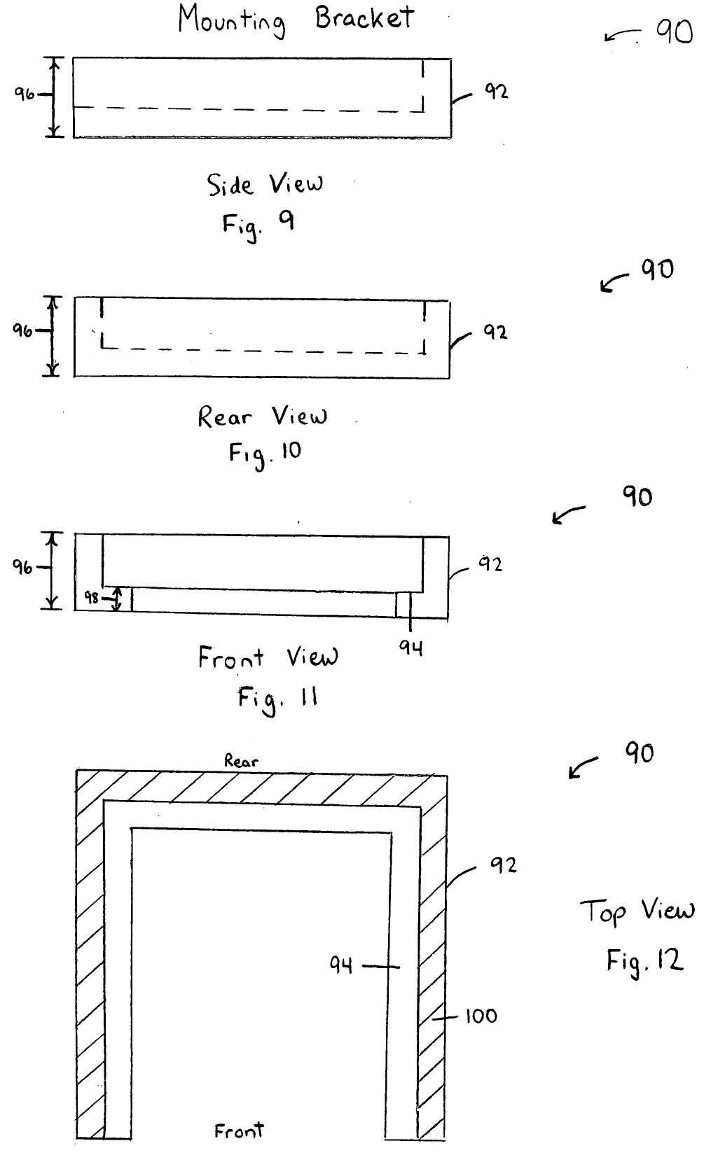

Referring now to FIGS. 9-12 there are shown side, rear, front, and top views of the mounting bracket 90 having an mounting bracket body 92, an interior flange 94, a mounting bracket exterior wall height 96, an interior flange height 98, and an adhesive top surface 100. In an exemplary embodiment, the mounting bracket body 92 is made from a hard plastic, although it can be made from a metal or any other suitable material. The mounting bracket body 92 is three-sided, and when viewed from the front, includes an interior flange 94 the runs the length of the three sides that receives the mounting bracket lip 74 of the L-shaped funnel sleeve member 70 as previously discussed in FIGS. 7-8. The interior flange 94 receives the mounting bracket lip 74 of the L-shaped funnel sleeve member in a friction-fit arrangement from the front of the mounting bracket body 92. The mounting bracket body is mounting bracket exterior wall height 96 tall on the outside of all three sides, and the interior flange 94 is interior flange height 98 tall on the inside of all three sides, resembling a “L” shape when viewed from the front.

FIG. 9 shows the mounting bracket 90 from a side view when looking at the commercial appliance, which in an exemplary embodiment is a refrigerator. When viewing from a side, the mounting bracket body 92 is visible and is mounting bracket exterior wall height 96 tall. The interior flange 94 is not visible from this view.

FIG. 10 shows the mounting bracket 90 from the rear view when looking at the commercial appliance, which in an exemplary embodiment is a refrigerator. When viewing from the rear, the mounting bracket body 92 is visible and is mounting bracket exterior wall height 96 tall. The interior flange 94 is not visible from this view.

FIG. 11 shows the mounting bracket 90 from the front view when looking at the commercial appliance, which in an exemplary embodiment is a refrigerator. When viewing from the front, the mounting bracket body 92 is visible and is mounting bracket exterior wall height 96 tall. The interior flange 94 is visible and is interior flange height 98 tall.

FIG. 12 shows the mounting bracket 90 from the top view when looking at the commercial appliance, which in an exemplary embodiment is a refrigerator. When viewing from above, the 3-sided configuration of the mounting bracket body 92 and the interior flange 94 are obvious and visible. The adhesive top surface 100 of the mounting bracket body 92 is visible by the angular shading.

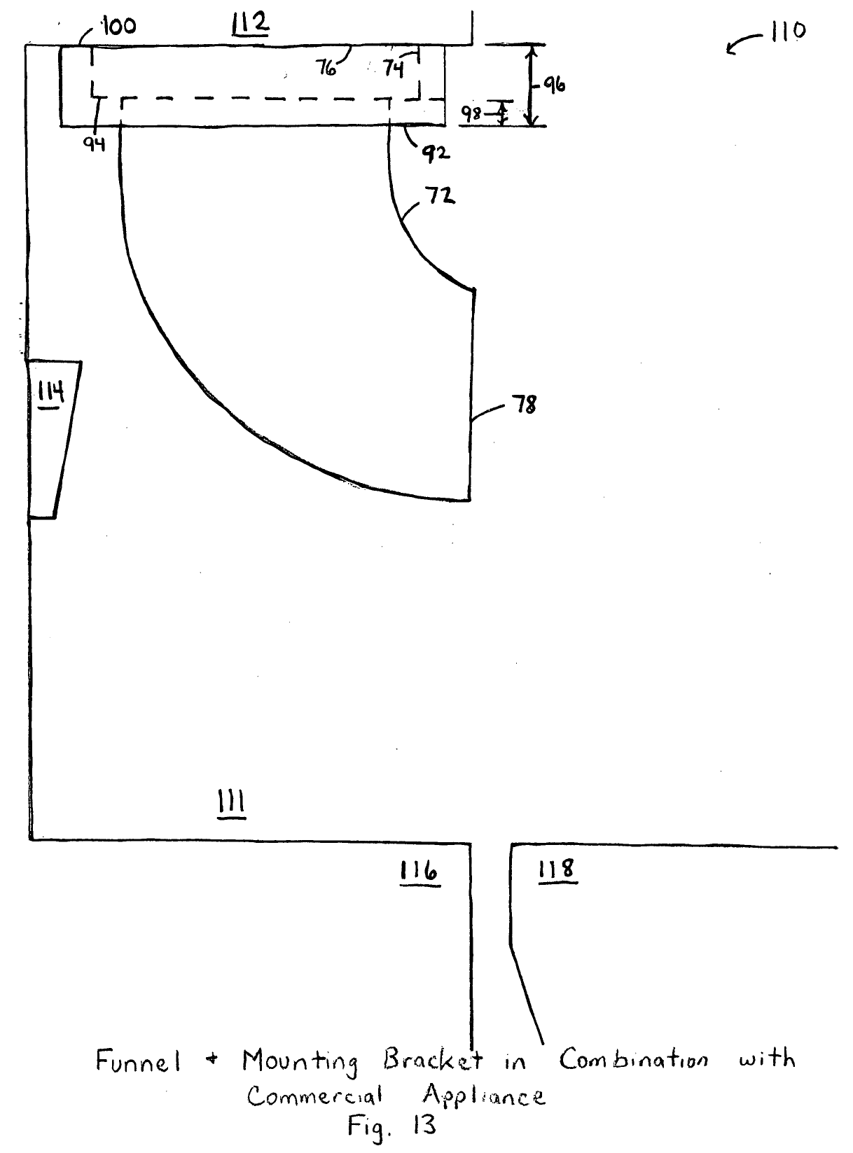

Referring now to FIG. 13 there is shown in profile a L-shaped funnel sleeve member in combination with a commercial appliance 110 in accordance with an exemplary embodiment of the present invention. As discussed previously in FIGS. 7-12 and herein in greater detail, the L-shaped funnel sleeve member in combination with a commercial appliance 110, in an exemplary embodiment, comprises the L-shaped funnel sleeve member body 72, the mounting bracket lip 74, the member input 76, the member output 78, the mounting bracket body 92, the interior flange 94, the adhesive top surface 100, a recessed dispensing cavity 111, an appliance output dispensing area 112, a dispensing button 114, a dispensing cavity lip 116, and a receiving container 118.

When used in combination, the L-shaped funnel sleeve member 72, in an exemplary embodiment, is operably coupled to the mounting bracket body 92 by a friction-fit arrangement, which is operably coupled to the water and ice dispenser area 112 by the adhesive top surface 100 of the mounting bracket body 92. Referring to FIGS. 9-12, the heights 96 and 98 are shown in profile for clarity sake and are also shown in FIG. 13.

When the user depresses by hand dispensing button 114, which can also be a dispensing pedal in a second exemplary embodiment, with one hand, product from the appliance output dispensing area 112 is released through the mounting bracket body 92 and sleeve member input 76, through the L-shaped body 72, and dispensed via the sleeve member output 78 into container 118, which can be held by the other hand or placed on a stationary object. The L-shaped funnel sleeve member body 72 allows the dispensed product to be redirected in order to overcome the dispensing cavity lip 116. This allows container 118, which can be larger than the dimensions of recessed dispensing cavity 111, to be filled while it is held by hand or placed on a stationary object.

Although preferred embodiments of the present invention are illustrated in the accompanied drawings and described in the foregoing detailed description, it will be understood that the invention is not limited to the embodiments disclosed but is capable of numerous rearrangements, modifications and substitutions in parts and elements without departing from the spirit of the invention. For example, any number of fastening mechanisms on the tabs of the liner can be used to accomplish the objectives of restraining the liner to the waste container, and thereafter can be used to secure the liner for disposal. Further, any number of motifs, such as cartoon characters or appealing designs, in the liner can be used to serve to motivate use of the trainer by the toddler and serve as an indicia that the liner needs to be replaced.

What is claimed is:

1. In combination:
a commercial appliance adapted to dispense a product at a product outlet; and
a sleeve member having an input and an output, the member input adapted to couple to the appliance outlet and redirect product dispensed from the appliance outlet and dispense the product via the member output.

2. The combination as specified in claim 1, wherein the commercial appliance comprises a refrigerator.

3. The combination as specified in claim 4, wherein the commercial appliance comprises an icemaker.

4. The combination as specified in claim 1, wherein the commercial appliance comprises a combination refrigerator and icemaker and the product is water and ice.

5. The combination as specified in claim 1, wherein the product comprises water.

6. The combination as specified in claim 1, wherein the product comprises ice.

7. The combination as specified in claim 1, wherein the member is rigid.

8. The combination as specified in claim 1, wherein the member is flexible.

9. The combination as specified in claim 1, wherein the member is extendible.

10. The combination as specified in claim 9, wherein the extendible member is accordion-like.

11. The combination as specified in claim 1, wherein the member input is operably coupled to the appliance outlet.

12. The combination as specified in claim 11, wherein the member input is operably coupled to the appliance outlet in a friction-fit arrangement.

13. The combination as specified in claim 11, wherein the member input is operably coupled to the appliance outlet in a mounting arrangement.

14. The combination as specified in claim 13, wherein the mounting arrangement comprises a mounting bracket.

15. The combination as specified in claim 14, wherein the mounting bracket is coupled to the appliance outlet by an adhesive.

16. The combination as specified in claim 16, wherein the mounting bracket is operably coupled to the member in a friction-fit arrangement.

17. The combination as specified in claim 1, wherein the deflection angle of the member is at least 20°.

18. The combination as specified in claim 1, wherein the optimal deflection angle of the member is 30°.

19. A method of coupling a sleeve member to a commercial appliance, the method comprising the steps of:
operably coupling a sleeve member input to a commercial appliance product outlet;
dispensing a product from the appliance outlet; and
redirecting the product dispensed from the appliance outlet via a member output.
